(19) United States
(12) Patent Application Publication
(10) Pub. No.: US 2006/0015440 A1
(43) Pub. Date: Jan. 19, 2006

(54) Dynamic liquidity management system

(76) Inventor: Neill Penney, Surrey (GB)

Correspondence Address: LAW OFFICES OF GRADY L. WHITE, LLC, 7272 WISCONSIN AVE, SUITE 300, BETHESDA, MD, 20814, US

(21) Appl. No.: 11/155,897

(22) Filed: Jun. 20, 2005

Related U.S. Application Data
(60) Provisional application No. 60/581,763, filed on Jun. 23, 2004.

(51) Int. Cl. G06Q 40/00

(52) U.S. Cl. 705/37

(57) ABSTRACT

The present invention provides systems and methods liquidity providers can use to manage and reduce their overall market exposure when multiple offers to deal are received substantially simultaneously. The invention automatically processes offers to deal according to provider-specified parameters, including a customer trading limit, a global trading limit and an offer to deal duration. Computer systems configured to operate according to principles of the invention include a provider communications interface for receiving provider-specified customer and global trading limits, a liquidity status database for storing current customer and global trading levels, a customer communications interface for receiving an offer to deal from a customer trading system, the offer to deal having a value, and a liquidity manager configured to reject the offer to deal if the sum of one of the current trading levels and the value exceeds one of the provider-specified trading limits. In preferred embodiments, the offers to deal or stored in an offer to deal database and periodically rechecked against the trading limits and the specified offer to deal duration.

### CROSS-REFERENCE TO RELATED APPLICATIONS

This application is related to and claims priority under 35 U.S.C. § 119 to provisional application No. 60/581,763, filed Jun. 23, 2004, which is incorporated into this application in its entirety by this reference.

### FIELD OF ART

The present invention relates generally to automated online asset trading systems and more particularly to automated online asset trading systems incorporating market risk management functionality.

### RELATED ART

In the asset trading business, including for example the foreign exchange (“FX”) and money markets, customers execute trades through asset dealers (typically, banks or banking institutions), who are referred to as “liquidity providers,” or simply “providers.” In a typical scenario, a customer wishing to buy, sell, lend or borrow some quantity of assets proposes a trading transaction by sending a request for price quotes (referred to as an “RFQ”) to one or more of the providers. The providers respond by returning price quotes for the proposed transaction, which indicate the prices the providers are willing to buy (or borrow) the assets, the prices they are willing to sell (or lend) the assets, as well as the size of the order the provider is willing to deal at the quoted prices. If a customer likes a price quote and wishes to enter into a deal with the sending provider, then the customer transmits to the provider an offer to trade assets for the price stated in the price quote (the offer is typically referred to as an “offer to deal”). If the price quote is still available (i.e., not expired) when the provider receives the customer's offer to deal, and the provider can meet other terms in the RFQ and offer to deal, such as the quantity ordered and the proposed settlement date, then the provider typically accepts the offer to deal, and the proposed transaction is booked and executed. In a slightly different scenario, providers may stream price quotes to customers on a substantially continuous basis without receiving a specific RFQ for each price quote, and customers may initiate a transaction by sending an offer to deal against one or more price quotes within the stream.

Automated asset trading systems have been introduced to facilitate faster, more efficient and, for auditing purposes, more traceable, trading transactions between customers and providers. Typically, these systems comprise a high-level trading application program (or, in some instances, a suite of high-level trading application programs) or a graphical user interface running on a customer's computer system (or network), which receives input from the user and sends electronic trading instructions to one or more high-level trading application programs running on the providers' computer systems (or networks). The customer's computer system and the providers' computer systems talk to each other by exchanging a series of messages via one or more data communication channels established within an interconnected computer network, such as the Internet, a dedicated wide area network (WAN), or a corporate intranet. Typically, the high-level trading application programs and graphical user interfaces create messages and transmit them over the computer network by accessing a predefined collection or library of subroutines and function calls. The collection or library of subroutines and function calls is referred to as an application programming interface (“API”).

With the help of the APIs, the messages carrying quotes, offers to deal and order instructions over the data communications links in the computer network may be channeled through an intermediate or centralized online trading server (or “portal”), which is also connected to the interconnected computer network. Typically, the intermediate online trading server is configured to coordinate, compare, match, error-check and/or log the messages on behalf of the customers and liquidity providers, and to communicate responses to the parties in real-time. In some cases, the online trading server is managed and operated by a third party. FX Alliance, LLC of New York, N.Y. (FXall) is one example of a third party operator of an online trading server for the FX market.

In the foreign exchange and money markets, the market prices for the assets fluctuate almost continuously. As a result of these continuously fluctuating prices, providers sending price quotes to customers are always exposed to a certain amount of financial risk; namely, that the prices in the market will change substantially between the time the provider publishes a price quote and the time the provider accepts an offer to deal on the price quote. In a worst case scenario, the market price for the particular assets in the deal could change so much in the time period between the publication of the price quote and the acceptance of the offer to deal that the provider can no longer sell assets at a higher price than he has agreed to buy them, or he can no longer purchase assets at a lower price than he has agreed to sell them.

Providers try to control and reduce their exposure by specifically limiting the quantity of assets associated with a given price quote. For example, when a provider publishes a price quote indicating a willingness to exchange (buy or sell) euros for U.S. dollars, he will indicate in the price quote that the price is good up to a maximum order size, such as $50 million (or an equivalent number of euros). By imposing a limit on the maximum order size for the quote, the provider ensures that he will not have to buy or sell more than $50 million worth of euros or U.S. dollars to satisfy an accepted offer to deal for this price quote.

Existing online trading systems are typically configured to flag an offer to deal received for a price quote when the quantity of assets requested in the offer to deal (i.e., the customer's order size) exceeds the provider-specified maximum order size. Some of the existing online trading systems may even be configured to automatically reject offers to deal having customer order sizes that exceed the provider's maximum order size. It has been found, however, that conventional online trading systems—even the systems capable of automatically rejecting offers to deal that exceed the maximum order size—have shortcomings that still expose providers to a significant an unacceptably high level of financial risk.

One significant shortcoming of conventional systems is that, while some of them can automatically reject offers to deal having order sizes that exceed the provider's maximum order size, they do not give the provider sufficient control over the automated offer to deal processing functions to prevent a particular customer from submitting a multiplicity of offers to deal, each one having an order size equal to or less than the provider's maximum order size, but which all together far exceed the provider's maximum order size and, possibly, the provider's supply of the quoted asset. For instance, if a provider publishes a price quote having a maximum order size of $50 million (or its foreign currency equivalent), the conventional systems do not prevent a single customer from rapidly submitting five, ten or even twenty offers to deal, each one having an individual value of no greater than $50 million. However the combined value of the five, ten or twenty offers to deal could be as great as $1 billion (i.e., 20 times $50 million).

Another shortcoming of conventional systems is that they typically do not give providers sufficient control over the automated offer to deal processing functions to prevent multiple customers from simultaneously (or substantially simultaneously) submitting an excessive number of offers to deal, all of which individually comply with the provider-specified maximum order size. Therefore, if a provider publishes a price quote having a maximum order size of $50 million, the provider could still be exposed to the possibility that five, ten, twenty or more customers could “hit” the price quote (i.e., submit offers to deal on the price quote) substantially simultaneously, which again exposes the provider to orders totaling as much as $1 billion, or more.

Accordingly, there is a considerable need in the online trading business for automated online trading systems, mechanisms and methods that give providers the ability to control the automatic processing of offers to deal, and more specifically, to control and/or limit the total value of offers to deal submitted by a single customer in a given time frame, as well as the total value of offers to deal submitted by all customers in a given time frame.

### SUMMARY OF THE INVENTION

The present invention addresses the above-described shortcomings of conventional online trading systems, as well as other needs and issues hereinafter described, by providing systems and methods for automatically processing offers to deal according to provider-specified trading limits for individual customers (hereinafter referred to as a “customer trading limit”) and provider-specified trading limits for all customers (hereinafter referred to as a “global trading limit”). With the present invention, providers can manage and reduce their overall market exposure when multiple offers to deal are received substantially simultaneously.

General features of preferred embodiments of the invention include: (1) the ability to place limits on the total value of offers to deal a provider can receive simultaneously; (2) the ability to automatically reject excessive offers to deal (i.e., offers to deal having a value that, combined with other offers to deal, will cause an exception to the specified limits); (3) the ability to track and automatically reject offers to deal that are received in a given time frame; (4) the ability to set a period of impact for received offers to deal (referred to below as “the OTD duration”); (5) the ability to set limits for particular customers, as well as all customers of a provider; (6) the ability to automatically send rejection notices to customers on behalf of providers; and (7) the ability to automatically send exception notices and/or warnings to providers when customer and global trading limits are breached.

Thus, in one aspect of the present invention, there is provided a computer system for processing offers to deal. The computer system comprises a provider communications interface for receiving a provider-specified customer trading limit for a customer trading system, a liquidity status database for storing a current trading level for the customer trading system, a customer communications interface for receiving an offer to deal from the customer trading system, the offer to deal having an OTD value, and a liquidity manager configured to reject the offer to deal if the sum of the customer's current trading level and the OTD value exceeds the provider-specified customer trading limit.

In preferred embodiments of this aspect of the invention, the liquidity manager is further configured to send the offer to deal to the provider trading system if the sum of the customer's current trading level and the OTD value does not exceed the provider-specified customer trading limit. The computer system may also be configured to send exception notices to the provider trading system when a customer or global trading limit would be breached by a received offer to deal. Preferred embodiments of this aspect of the invention also include an offer to deal database for storing offers to deal as they are received. In addition, the computer system of the present invention may also be configured to retrieve from a liquidity status database, or alternatively, to receive, via the provider communications interface, a provider-specified global trading limit, which limits the total value of all offers to deal sent to the provider trading system by all of the provider's customers. The invention automatically rejects an offer to deal when the additional value of the requested trade in the offer to deal, combined with the current total value of all requested or actual trades, exceeds the global trading limit set by the provider.

This aspect of the invention may also be configured to establish a period of impact (called an OTD duration), which basically defines how long a received offer to deal will be held before being rejected and/or deleted. The system may be configured, if desired, to automatically reject additional offers to deal received from the customer during this period. A provider may use this feature to specify, for instance, that when a particular customer submits an offer to deal, that offer to deal will have an OTD duration of three (3) seconds, and any offers to deal received from that customer during that three-second period will be automatically rejected. The OTD duration may be retrieved from the provider trading system, or alternatively, established by the operator of the intermediate online asset trading server. In either case, the OTD duration is typically stored in the liquidity status database and retrieved by the liquidity manager when required for testing. Systems operating according the invention may be configured to use a single OTD duration for all offers to deal, a customer-specific offer to deal duration for each customer trading system, or a provider-specific OTD duration for each provider trading system.

In another aspect of the invention, there is provided a method for processing offers to deal in an online asset trading system, the method comprising: (1) receiving from a provider trading system, via a provider communications interface, a trading limit for a customer trading system; (2) determining a current trading level for the customer trading system; (3) receiving from the customer trading system, via a customer communications interface, an offer to deal, the offer to deal comprising an OTD value; and (4) rejecting the offer to deal if the sum of the current trading level for the customer and the OTD value exceeds the customer trading limit. Preferred embodiments of the method also include the steps of sending the offer to deal to the provider trading system if the sum of the customer's current trading level and the OTD value does not exceed the customer trading limit.

A further option in the method includes the steps of establishing an OTD duration, receiving from the customer trading system, via the customer communications interface, a second offer to deal, calculating an age for the original offer to deal, and rejecting the second offer to deal if the age is less than or equal to the established OTD duration. In this aspect of the invention, checking for customer trading limit exceptions is required, while checking for global trading limit exceptions is only an optional additional feature. Other aspects of the claimed invention include the same steps, except that the step of checking for global trading limit exceptions is a required step. In other words, these other aspects check for both types of exceptions (customer and global), automatically rejects offers to deal if either type of exception is detected, and automatically sends offers to deal to the provider trading system if neither type of exception is detected.

In some aspects of the invention, the invention automatically rejects offers to deal that cause exceptions immediately. In other embodiments, the invention does not reject offers to deal immediately. Instead, the exception is recorded and the offer to deal is stored in an offer to deal database for a specified period of time (the OTD duration) to be periodically retrieved and re-tested to determine whether its value would still generate a breach of the provider-specified customer or global limits. If the customer and global actual trading levels (the actual trading levels representing the market exposure for a provider) are sufficiently reduced before the OTD duration expires (so that no exception would occur), then the offer to deal may be automatically removed from the offer to deal database and sent to the provider trading system.

Consistent with this aspect of the invention, there is provided a computer system for processing offers to deal, which comprises a provider communications interface for receiving a customer trading limit and a global trading limit, a liquidity status database comprising a customer current actual trading level for the customer trading system and a global current actual trading level for the provider trading system, a customer communications interface for receiving from the customer trading system an offer to deal, the offer to deal comprising an OTD value, and a liquidity manager configured to record an exception in the liquidity status database if the sum of the customer current actual trading level and the OTD value exceeds the customer trading limit or if the sum of the global current actual trading level and the OTD value exceeds the global trading limit. On the other hand, if the sum of the customer current actual trading level and the OTD value does not exceed the customer trading limit and the sum of the global current actual trading level and the OTD value does not exceed the global trading limit, then the liquidity manager is configured to send the offer to deal to the provider trading system via the provider communications interface.

Rather than be immediately rejected, the offer to deal is stored in an offer to deal database. The liquidity manager comprises an OTD duration processor with a data structure for storing a counter value initialized to reflect the total number of offers to deal stored in the offer to deal database. The OTD duration processor then operates to iteratively increment the counter value while performing three steps if the counter value remains less than the total number of offers to deal. Those three steps include: (a) retrieving a stored offer to deal from the offer to deal database, the stored offer to deal having a stored OTD value; (b) determining an age for the stored offer to deal; and (c) if the age does not exceed an established OTD duration, then (i) retrieving from the liquidity status database a stored customer trading limit, a stored customer current actual trading level, a stored global trading limit and a stored global current actual trading level, and (ii) if the sum of the stored customer current actual trading level and the stored OTD value does not exceed the stored customer trading limit and the sum of the stored global current actual trading level and the stored OTD value does not exceed the global trading limit, then sending the stored offer to deal to the appropriate provider trading system. However, if the age does exceed the established OTD duration, then the third step (step c) is reduced to deleting the stored offer to deal from the offer to deal database.

Responsive to the customer communications interface receiving the offer to deal, the liquidity manager retrieves from the liquidity status database a customer current requested trading level for the customer trading system and a global current requested trading level for the provider trading system. These current requested trading levels are then incremented to reflect the additional value of incoming offers to deal. Conversely, the requested trading levels are decremented by the OTD value when offers to deal are deleted from the offer to deal database (either because they expired, or because they were accepted or rejected by the provider trading system and no longer represent a market exposure).

Preferred embodiments of all of the above-summarized aspects of the invention include components and/or steps for determining, tracking, storing and updating (i.e., incrementing and decrementing) the current customer and global requested trading levels (a requested level being the total value of offers to deal received by the invention), and the current customer and global actual trading levels (an actual trading level being the total value of offers to deal the system has transmitted to the provider trading system). Preferred embodiments also include components and/or steps for determining, tracking, storing and updating provider-specified customer and global trading limits.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include depictions of the exemplary embodiments. In these drawings:

FIG. 1 contains a high-level block diagram illustrating the major functional components of an online trading system configured to operate according to an embodiment of the invention.

FIGS. 2, 3 and 4 contain high-level flow diagrams illustrating the steps that might be performed in an online trading server configured to operate according to an embodiment of the invention, such as, for example, the online trading server depicted in FIG. 1.

### DETAILED DESCRIPTION OF PREFERRED EMBODIMENTS

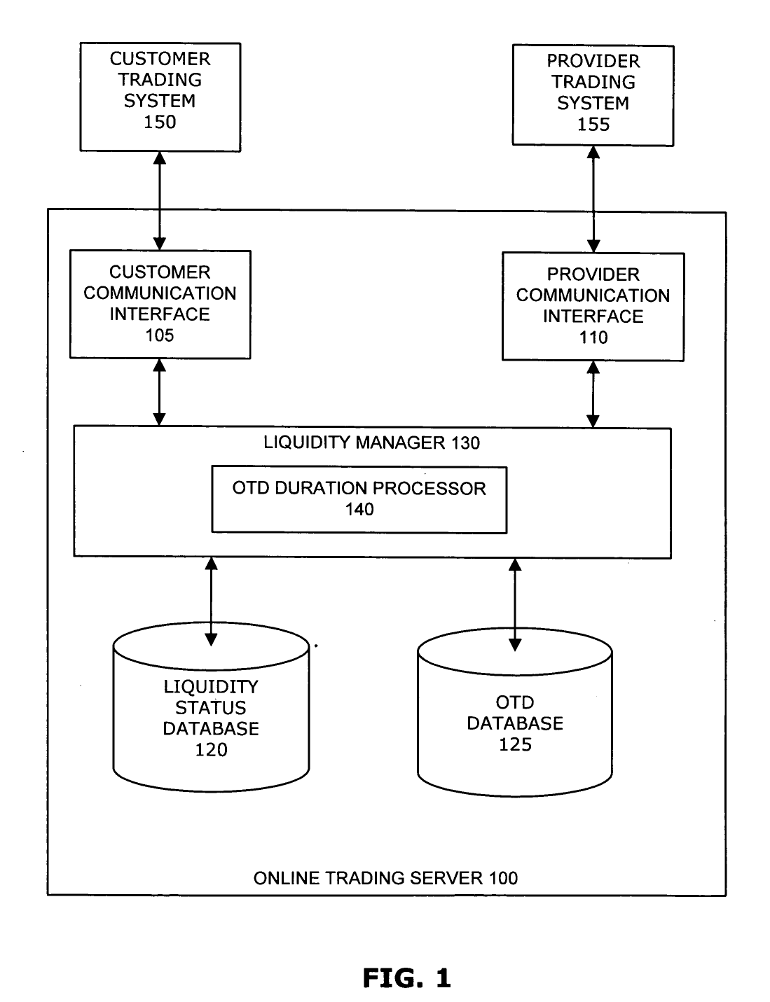

With reference to FIGS. 1 through 4, a detailed discussion of exemplary embodiments of the invention will now be presented. Notably, the invention may be implemented using software, hardware, firmware, or any combination thereof, as would be apparent to those of skill in the art upon reading this disclosure.

FIG. 1 contains a high-level block diagram illustrating the major functional components of an online trading server configured to operate according to an embodiment of the invention. As shown in FIG. 1, online trading server 100 comprises a customer communication interface 105, a provider communication interface 110, a liquidity manager 130, a liquidity database 120 and an offer to deal database 125. The customer communication interface 105 is configured to receive offers to deal and other trading messages from a customer trading system 150 (via a link through a data communications network, such as the Internet) and to transmit those messages to the liquidity manager 130 for further processing. Customer communications interface also transmits to customer trading system 150 price quotes, confirmations, rejections and other trading instructions and messages generated by online trading server 100 and/or provider trading system 155. Provider communication interface 110 is configured to transmit offers to deal to provider trading system 155, and to receive from provider trading system 155 responses to those offers to deal, customer trading limits and global trading limits.

For purposes of making the drawings and the discussion that follows easier to understand, FIG. 1 shows only one customer communication interface coupled to only one customer trading system, and only one provider communications interface coupled to only one provider trading system. It should be understood, however, that preferred embodiments of the invention incorporate a multiplicity of customer communication interfaces coupled (via a multiplicity of data communications links) to a multiplicity of customer trading systems, and a multiplicity of provider communication interfaces coupled to a multiplicity of provider trading systems (via a multiplicity of data communications links).

Liquidity manager 130 performs a substantial portion of the liquidity management functions of the present invention, including receiving incoming offers to deal from customer trading system 150 via customer communications interface 105, storing those incoming offers to deal in offer to deal database 125, retrieving system-monitored liquidity status parameters (such as the customer and global trading limits, and the current and actual trading levels) from liquidity status database 120, testing the value of the incoming offers to deal against the system-monitored liquidity status parameters, and, based on the results of the testing, sending offers to deal and/or exception notices to provider trading system 155 via provider communication interface 110. Liquidity manager 130 also increments and decrements the system-monitored liquidity status parameters, as necessary, and stores the updated values back in the liquidity status database.

In preferred embodiments, liquidity manager 130 comprises an OTD duration processor configured to continually check offers to deal stored in the database against a provider-specified OTD duration parameter, and to delete from the database offers to deal that are older than the specified duration period and are, therefore, expired and no longer dealable. When this occurs, liquidity manager 130 is typically configured to send a time out, expiration or “deal denied” message to customer trading system 150 via customer communication interface 105.

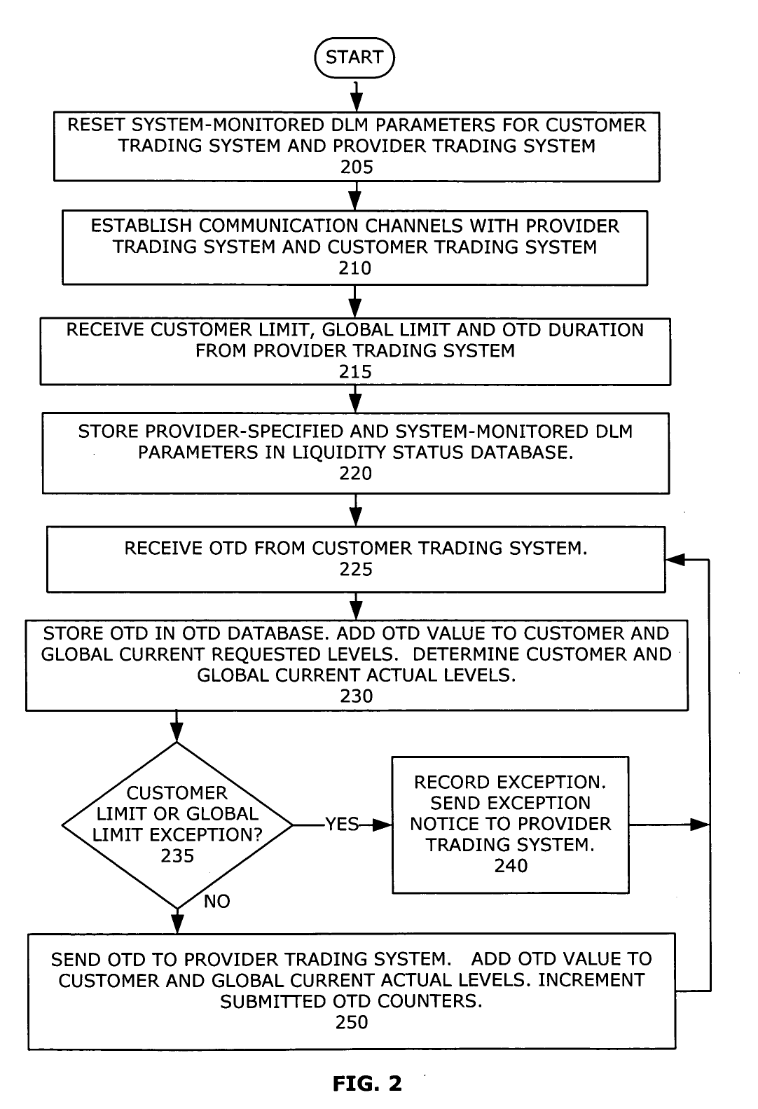

FIGS. 2, 3 and 4 contain high-level flow diagrams illustrating in general terms the steps that might be performed by an online trading server, such as online trading server 100 depicted in FIG. 1, configured to process incoming offers to deal according to embodiments of the invention. However, more specific details related to the general steps shown in FIGS. 2, 3 and 4 (and described below) may be understood by reference to the following exemplary liquidity status database variables, exemplary algorithms and exemplary operational modes.

Liquidity Status Database Parameters:

| | |
|---|---|
| L₁, . . . , Lₙ | customer limits |
| l₁, . . . , lₙ | customer current actual levels |
| r₁, . . . , rₙ | customer current requested levels |
| a₁, . . . , aₙ | current OTDs submitted by customer and submitted to |
| | provider |
| e₁, . . . , eₙ | Today's exceptions by customer |
| m₁, . . . , mₙ | Today's peak requested usage by customer |
| L | global limit |
| l | global current actual level for provider |
| r | global current requested level for provider |
| a | Current OTDs submitted by all customers and submitted to |
| | provider |
| e | Today's global exceptions |
| m | Today's peak requested usage by all customers |
| D | OTD Duration (in seconds) |

Operational Mode 1: Initialization Steps

As shown in FIG. 2 at step 205, the first step is to reset the system-monitored liquidity parameters (l₁, . . . , lₙ, r₁, . . . , rₙ, a₁, . . . , aₙ, e₁, . . . , eₙ, m₁, . . . , mₙ, l, r, a, e and m) to zero. This step would typically be performed, for example, at the beginning of the day. The next step, shown as step 210 in FIG. 2, is to establish communication channels with a provider trading system and a customer trading system. This may be accomplished, in preferred embodiments, by activating provider communication interface 110 and customer communication interface 105 to respond to and validate login requests submitted by the operators of provider trading system 155 and customer trading system 150. It should be understood, however, that establishing communication with the customer trading system near or at the same time as establishing communication with the provider trading system is not a requirement of the invention. In fact, establishing communication with the customer trading system may not occur for a substantial period of time after the provider trading system has completed the logon process, supplied certain liquidity status parameters, and started sending quotes to customer trading systems.

Next, at step 215, the system receives a set of provider-specified liquidity status parameters, including customer trading limits, a global trading limit and an OTD duration (L₁ . . . Lₙ, L and D), from the provider trading system and stores both the system-monitored parameters and provider-specified parameters in the liquidity status database (step 220). At this point, the system is ready to start receiving offers to deal from customer trading systems.

Operational Mode 2: Receiving a New Offer to Deal

As shown in step 225 of FIG. 2, suppose at time t, customer i sends an offer to deal to online trading server 100. The offer to deal has an ID x and a trade value of v (in USD). At step 230, the system stores the offer to deal in an offer to deal database (such as offer to deal database 125 in FIG. 1), and retrieves from a liquidity status database (e.g., liquidity status database 120) the customer and global current requested levels, as well as customer and global daily peaks. These liquidity status parameters are appropriately incremented by the OTD value v. Thus, preferred embodiments of the invention may be configured to execute the following instructions:
store OTD(x) details (i, x, v, t) in the OTD database
set rᵢ←rᵢ+v
if rᵢ>mᵢ, then set mᵢ←rᵢ
set r←r+v
if r>m, then set m←r

Next, at step 235, the system compares the sum of the current trading level for the customer and the value of the received offer to deal against the provider-specified trading limit for the customer. If the sum of the current customer actual level and the OTD value exceeds the customer trading limit, then the invention records a new customer exception for customer i and sends a customer exception notification to the provider trading system (as shown in step 240). Accordingly, preferred embodiments of the invention may be configured to execute the following instructions:
If lᵢ+v>Lᵢ, then
   set eᵢ←eᵢ+1
   send eᵢ to provider

If no customer exception occurred, the system also determines whether a global exception has occurred (also shown at step 235). The offer to deal causes a global exception if the sum of the global current actual trading level (retrieved from the liquidity status database) and the OTD value of the offer to deal exceeds the provider-specified global trading limit. If the offer to deal causes a global exception, then the system sends a global exception notification to the provider trading system (as shown in step 240). In preferred embodiments, these instructions are:
if l+v>L, then
set e←e+1
send e to provider trading system

If the offer to deal (x) does not cause a customer or global exception, then the offer to deal details (i, x, v, t) for offer to deal (x) are sent to the provider trading system via provider communication interface 110, the OTD value v is added to the customer and global current actual levels, and the customer and global submitted OTD counters are incremented (step 250). Thus, the system is configured to execute:
set lᵢ←lᵢ+v
set l←l+v
set aᵢ←aᵢ+1
set a←a+1

Operational Mode 3: Expiration of OTD Duration

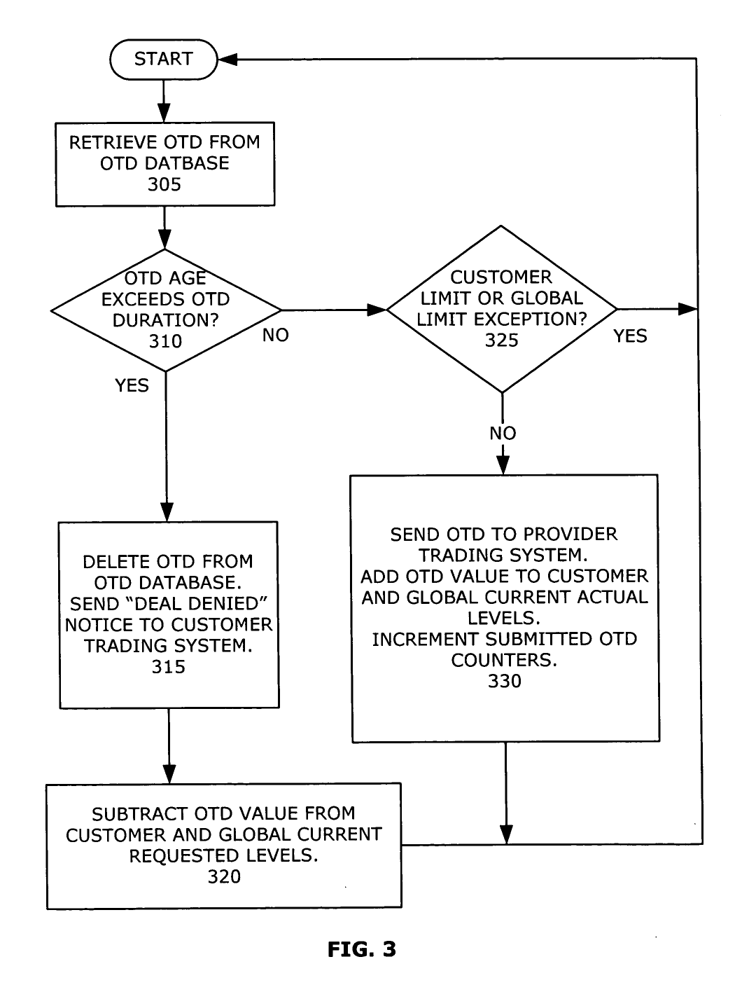

The steps performed by preferred embodiments of the invention when an offer to deal expires (i.e., becomes older than the provider-specified OTD duration) will now be described below with reference to FIG. 3. As stated above, in some aspects of the invention, offers to deal received by the liquidity manager and which cause a customer or global exception are immediately rejected by the system. In other aspects, however, the exception-causing offers to deal are not immediately rejected. Instead, they are stored in the offer to deal database and then periodically re-checked at a later time to determine whether they have expired or still cause a customer or global limit to be exceeded.

When an offer to deal has existed in the offer to deal database for a period that is equal to or longer than the OTD Duration (D), it is time to remove that offer to deal from the offer to deal database and update the liquidity status for that customer and provider by adjusting the appropriate parameters and counters contained in the liquidity status database. Otherwise, the system again tests the value of the offer to deal against the customer and global limits to see if it causes another exception. These steps may be performed, for example, by the OTD duration processor 140, depicted in FIG. 1, which preferably includes a data structure for storing a counter value initialized to reflect the total number of offers to deal stored in the offer to deal database.

The first steps in this mode, as shown in FIG. 3 at steps 305 and 310, are to retrieve an offer to deal from the offer to deal database and check its age. The age of the offer to deal may be determined, for example, by subtracting the OTD receipt time t from the current time. If the offer to deal's age exceeds the OTD Duration (D), then the offer to deal and its details are deleted from the offer to deal database, and a notification is sent to the customer trading system (step 315). Exemplary instructions for this are:
If Current_time−t>D, then:
   delete OTD(x) details (i, x, v, t) from the OTD database
   send “deal denied” message to the customer trading system

Next, as shown in step 320, the OTD value v is subtracted from the customer and global current requested levels:
set rᵢ←rᵢ−v
set r←r−v

However, if it is determined at step 310 that the age of the offer to deal is less than or equal to (not greater than) the provider-specified OTD duration, then processing continues at step 325, wherein the offer to deal is tested again to see if it still creates a customer or global exception. In preferred embodiments, each offer to deal stored in the offer to deal database has associated with it an identifier (i) indicating which customer trading system submitted the offer to deal, as well as an identifier (p) associating the offer to deal with a particular provider trading system. Using these identifiers i and p, the system retrieves from the liquidity status database the liquidity status parameters it needs (such as the customer current actual trading level for the customer trading system i, and the global current actual trading level for the provider trading system p) to perform the age and exception testing.

If there is an exception (i.e., if the sum of the current actual level and the OTD value still exceeds a customer or global limit), then the offer to deal is left in the offer to deal database, the OTD duration processor counter is incremented, and processing returns to step 305, where the next offer to deal is retrieved from the offer to deal database for testing. The next offer to deal retrieved may be another offer to deal from the same customer or it could be an offer to deal sent by a different customer. On the other hand, if it is determined at step 325 that the offer to deal does not create another exception, then processing continues at step 330, wherein the OTD details (i, x, v, t) are sent to the provider trading system, the OTD value v is subtracted from the customer and global current requested levels, the OTD value v is added to the customer and global current actual levels, and the customer and global submitted OTD counters are incremented. Exemplary instructions for step 325 are as follows:
send OTD details to provider trading system
set lᵢ←lᵢ+v
set l←l+v
set aᵢ←aᵢ+1
set a←a+1

Operational Mode 4: Receiving a Response to Offer to Deal (x)

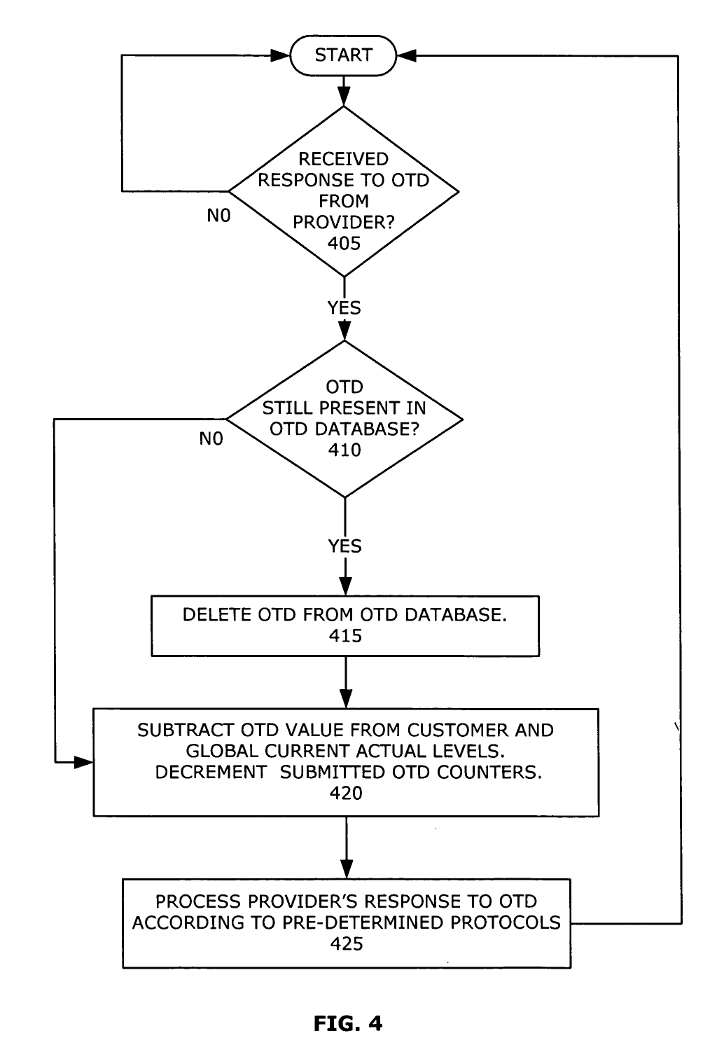

FIG. 4 shows an exemplary high-level flow diagram depicting the steps preferred embodiments of the invention are configured to perform when a response to an offer to deal from the provider trading system. At shown in step 405, the system periodically checks to determine whether it has received a response to an offer to deal from the provider trading system. Suppose it is determined at step 405, for example, that at time t(2), the system received from the provider trading system a response to offer to deal (x). At step 410, the system checks the offer to deal database for offer to deal (x). If offer to deal (x) is still present in the offer to deal database, then t(2) must have occurred before the OTD duration expired (i.e., while t(2)−t<=D). In this case, it would now be appropriate to go ahead and delete OTD(x) from the OTD database (step 415 in FIG. 4).

However, if offer to deal (x) is no longer present in the offer to deal database, then t(2) must have occurred after the OTD duration expired (i.e., while t(2)−t>D), and offer to deal (x) has already been removed from the database by the operational mode 3 processing steps described above. Under these circumstances, step 415 in FIG. 2 is skipped, and processing proceeds directly to step 420, described below.

In either case, the liquidity status counters need to be unwound. As shown in Step 420, this is accomplished by subtracting the OTD value v for offer to deal (x) from the customer and global current actual levels, and decrementing the customer and global submitted OTD counters. Exemplary instructions for accomplishing this include the instructions:
set lᵢ←lᵢ−v
set l←l−v
set aᵢ←aᵢ−1
set a←a−1

Finally, the provider's response to the offer to deal is processed according to a pre-determined protocol (step 425). For example, if the system receives from the provider trading system a response comprising a rejection of an offer to deal that has already expired (and, as a consequence, has already been removed from the offer to deal database), then the system may be configured, depending on the operator's desired protocols, to inform the customer trading system that the offer to deal expired before the provider responded, that the provider denied offer to deal, or both. On the other hand, if the provider's response included an acceptance of the expired offer to deal, then system may be configured, again depending on the operator's desired protocols, to inform the provider trading system that the offer to deal expired before the acceptance was received. In this case, the system may be configured, for example, to permit the customer and provider to negotiate a new deal or to revive of the expired offer to deal. At this point, processing returns to step 405, wherein the system checks again to determine whether it has received a response to an offer to deal from the provider trading system.

Preferred embodiments of the invention, as described above and shown in the figures are configured to operate in conjunction with the applications and graphical user interfaces running on the provider trading systems. It is anticipated, for example, that some providers will submit the provider-specified parameters, such as the customer and global trading limits and the OTD duration to the online trading server by entering the desired settings into fields presented on their computer screens via a graphical user interface, which will in turn cause those settings to be transmitted, via an interconnected data communications network, such as the Internet, to the online trading server, where it will be stored in the liquidity status database for use by other components of the invention. It is further anticipated that the invention may be configured, according to methods known in the computer networking industry, to periodically transfer the system-monitored liquidity status parameters stored in the liquidity status database to the provider's graphical user interface for review and modification by the provider.

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims. Therefore, for example, it should be understood by one skilled in the art that the present invention is not limited to foreign exchange transactions, and may be beneficially applied to other types of transactions as described above.

What is claimed is:

1. A computer system for processing offers to deal, comprising:
a provider communications interface for receiving from a provider trading system a customer trading limit for a customer trading system;
a liquidity status database for storing a customer current trading level for said customer trading system;
a customer communications interface for receiving an offer to deal from said customer trading system, said offer to deal comprising an OTD value; and
a liquidity manager configured to reject said offer to deal if the sum of said customer current trading level and said OTD value exceeds said customer trading limit.

2. The computer system of claim 1, wherein said liquidity manager is further configured to send said customer trading system a rejection notice via said customer communications interface.

3. The computer system of claim 1, wherein said liquidity manager is further configured to send an exception notice to said provider trading system via said provider communications interface.

4. The computer system of claim 1, further comprising:
an offer to deal database; and
said liquidity is further configured to store said offer to deal in said offer to deal database.

5. The computer system of claim 1, wherein said liquidity manager is further configured to send said offer to deal to said provider trading system via said provider communications interface if the sum of said customer current trading level and said OTD value does not exceed said customer trading limit.

6. The computer system of claim 5, wherein said liquidity manager is further configured to increment said customer current trading level by said OTD value.

7. The computer system of claim 6, wherein said liquidity manager is further configured:
to receive from said provider trading system, via said provider communications interface, a response to said offer to deal; and
to decrement said customer current trading level by said OTD value.

8. The computer system of claim 1, wherein said liquidity manager is further configured:
to receive from said customer trading system, via said customer communications interface, a second offer to deal;
to calculate an age for said offer to deal; and
to reject said second offer to deal if said age is less than or equal to an established OTD duration.

9. The computer system of claim 8, wherein said liquidity manager receives said established OTD duration from said provider trading system via said provider communications interface.

10. The computer system of claim 1, wherein said liquidity manager:
receives from said provider trading system, via said provider communications interface, a global trading limit;
determines a global current trading level; and
rejects said offer to deal if the sum of said global current trading level and said OTD value exceeds said global trading limit.

11. The computer system of claim 10, wherein said liquidity manager retrieves said global current trading level from said liquidity status database.

12. The computer system of claim 10, wherein said liquidity manager sends said customer trading system a rejection notice via said customer communications interface.

13. The computer system of claim 10, wherein said liquidity manager sends an exception notice to said provider trading system via said provider communications interface.

14. The computer system of claim 10, wherein said liquidity manager sends said offer to deal to said provider trading system via said provider communications interface if the sum of said global current trading level and said OTD value does not exceed said global trading limit.

15. The computer system of claim 14, wherein said liquidity manager increments said global current trading level by said OTD value.

16. The computer system of claim 15, wherein said liquidity manager:
receives from said provider trading system, via said provider communications interface, a response to said offer to deal; and
decrements said global current trading level by said OTD value.

17. A method for processing offers to deal in an online asset trading system, comprising:
receiving from a provider trading system, via a provider communications interface, a customer trading limit for a customer trading system;
determining a customer current trading level for said customer trading system;
receiving from said customer trading system, via a customer communications interface, an offer to deal, said offer to deal comprising an OTD value; and
rejecting said offer to deal if the sum of said customer current trading level and said OTD value exceeds said customer trading limit.

18. The method of claim 17, further comprising:
providing a liquidity status database; and
retrieving said customer current trading level from said liquidity status database.

19. The method of claim 17, further comprising sending said customer trading system a rejection notice via said customer communications interface.

20. The method of claim 17, further comprising sending an exception notice to said provider trading system via said provider communications interface.

21. The method of claim 17, further comprising:
providing an offer to deal database; and
storing said offer to deal in said offer to deal database.

22. The method of claim 17, further comprising sending said offer to deal to said provider trading system via said provider communications interface if the sum of said customer current trading level and said OTD value does not exceed said customer trading limit.

23. The method of claim 22, further comprising incrementing said customer current trading level by said OTD value.

24. The method of claim 22, further comprising:
receiving from said provider trading system, via said provider communications interface, a response to said offer to deal; and
decrementing said customer current trading level by said OTD value.

25. The method of claim 17, further comprising:
establishing an OTD duration;
receiving from said customer trading system, via said customer communications interface, a second offer to deal;
calculating an age for said offer to deal; and
rejecting said second offer to deal if said age is less than or equal to said OTD duration.

26. The method of claim 25, further comprising receiving said OTD duration from said provider trading system via said provider communications interface.

27. The method of claim 17, further comprising:
receiving from said provider trading system, via said provider communications interface, a global trading limit;
determining a global current trading level; and
rejecting said offer to deal if the sum of said global current trading level and said OTD value exceeds said global trading limit.

28. The method of claim 27, further comprising:
providing a liquidity status database; and
retrieving said global current trading level from said liquidity status database.

29. The method of claim 27, wherein said step of rejecting said offer to deal comprises sending said customer trading system a rejection notice via said customer communications interface.

30. The method of claim 27, further comprising sending an exception notice to said provider trading system via said provider communications interface.

31. The method of claim 27, further comprising sending said offer to deal to said provider trading system via said provider communications interface if the sum of said global current trading level and said OTD value does not exceed said global trading limit.

32. The method of claim 31, further comprising incrementing said global current trading level by said OTD value.

33. The method of claim 32, further comprising:
receiving from said provider trading system, via said provider communications interface, a response to said offer to deal; and
decrementing said global current trading level by said OTD value.

34. A method for processing offers to deal in an online asset trading system, comprising:
receiving from a provider trading system, via a provider communications interface, a customer trading limit for a customer trading system and a global trading limit for said provider trading system;
determining a customer current trading level for said customer trading system and a global current trading level for said provider trading system;
receiving from said customer trading system, via a customer communications interface, an offer to deal, said offer to deal comprising an OTD value;
rejecting said offer to deal if the sum of said customer current trading level and said OTD value exceeds said customer trading limit or if the sum of said global current trading level and said OTD value exceeds said global trading limit.

35. The method of claim 34, further comprising:
providing a liquidity status database; and
retrieving said customer current trading level and said global current trading level from said liquidity status database.

36. The method of claim 34, further comprising sending said customer trading system a rejection notice via said customer communications interface.

37. The method of claim 34, further comprising sending an exception notice to said provider trading system via said provider communications interface.

38. The method of claim 34, further comprising:
providing an offer to deal database; and
storing said offer to deal in said offer to deal database.

39. The method of claim 34, further comprising sending said offer to deal to said provider trading system via said provider communications interface if the sum of said customer current trading level and said OTD value does not exceed said customer trading limit and the sum of said global current trading level and said OTD value does not exceed said global trading limit.

40. The method of claim 39, further comprising incrementing said customer current trading level and said global current trading level by said OTD value.

41. The method of claim 40, further comprising:
receiving from said provider trading system, via said provider communications interface, a response to said offer to deal; and
decrementing said customer current trading level and said global current trading level by said OTD value.

42. The method of claim 34, further comprising:
receiving from said provider trading system, via said provider communications interface, an OTD duration;
receiving from said customer trading system, via said customer communications interface, a second offer to deal;
calculating an age for said offer to deal; and
rejecting said second offer to deal if said age is less than or equal to said OTD duration.

43. A computer system for processing offers to deal, comprising:
a provider communications interface for receiving from a provider trading system a customer trading limit for a customer trading system and a global trading limit for said provider trading system;
a liquidity status database comprising a customer current actual trading level for said customer trading system and a global current actual trading level for said provider trading system;
a customer communications interface for receiving from said customer trading system an offer to deal, said offer to deal comprising an OTD value; and
a liquidity manager configured to record an exception in said liquidity status database if the sum of said customer current actual trading level and said OTD value exceeds said customer trading limit or the sum of said global current actual trading level and said OTD value exceeds said global trading limit, and if not, to send said offer to deal to said provider trading system via said provider communications interface.

44. The computer system of claim 43, wherein said liquidity manager sends a notice concerning said exception to said provider trading system via said provider communications interface.

45. The computer system of claim 43, wherein said liquidity manager is further configured to increment said customer current actual trading level and said global current actual trading level by said OTD value.

46. The computer system of claim 43, wherein:
responsive to said customer communications interface receiving said offer to deal, said liquidity manager (i) retrieves from said liquidity status database a customer current requested trading level for said customer trading system and a global current requested trading level for said provider trading system, and (ii) increments said customer current requested trading level and said global current requested trading level by said OTD value.

47. The computer system of claim 43, wherein
said offer to deal is stored in an offer to deal database; and
said liquidity manager comprises an OTD duration processor having a data structure for storing a counter value initialized to a total number of offers to deal stored in said offer to deal database, said OTD duration processor being operable to iteratively increment said counter value and perform the following steps (a)-(c) if said counter value is less than said total number of offers to deal;
(a) retrieving a stored offer to deal from said offer to deal database, said stored offer to deal having a stored OTD value;
(b) determining an age for said stored offer to deal; and
(c) if said age does not exceed an established OTD duration, then
(i) retrieving from said liquidity status database a stored customer trading limit, a stored customer current actual trading level, a stored global trading limit and a stored global current actual trading level, and
(ii) if the sum of said stored customer current actual trading level and said stored OTD value does not exceed said stored customer trading limit and the sum of said stored global current actual trading level and said stored OTD value does not exceed said global trading limit, then sending said stored offer to deal to said related provider trading system,
else, deleting said stored offer to deal from said offer to deal database.

48. The computer system of claim 47, wherein said OTD duration processor is further configured to increment said stored customer current actual trading level and said stored global current actual trading level by said stored OTD value.

49. The computer system of claim 48, wherein said liquidity manager is further configured:
to receive a response to said stored offer to deal;
to delete said stored offer to deal from said offer to deal database; and
to decrement said stored customer current actual trading level and said stored global current actual trading level by said stored OTD value.

50. The computer system of claim 49, wherein said liquidity manager is further configured to decrement said stored customer current requested trading level and said stored global current requested trading level by said stored OTD value.

51. The computer system of claim 47, wherein said OTD duration processor is further configured:
to retrieve from said liquidity status database a stored customer current requested trading level and a stored global current requested trading level; and
to decrement said stored customer current requested trading level and said stored global current requested trading level by said stored OTD value.

52. The computer system of claim 47, wherein said liquidity manager is further configured to retrieve said established OTD duration from said liquidity status database.

53. The computer system of claim 52, wherein said liquidity manager is further configured to store in said liquidity status database one or more of:
said stored customer current actual trading level,
said stored global current actual trading level,
said stored customer trading limit,
said stored global trading limit,
said OTD duration, and
said exception.

54. The computer system of claim 53, wherein said liquidity manager is further configured to permit said provider trading system access, via said provider communications interface, to data stored in said liquidity status database.

55. A method for processing offers to deal in an online asset trading system, comprising:
receiving from a provider trading system, via a provider communications interface, a customer trading limit for a customer trading system and a global trading limit for said provider trading system;
determining a customer current actual trading level and a global current actual trading level;
receiving from said customer trading system, via a customer communications interface, an offer to deal, said offer to deal comprising an OTD value;
storing said offer to deal in an offer to deal database; and
if the sum of said customer current actual trading level and said OTD value does not exceed said customer trading limit and the sum of said global current actual trading level and said OTD value does not exceed said global trading limit, then sending said offer to deal to said provider trading system via said provider communications interface, else recording an exception.

56. The method of claim 55, further comprising sending a notice concerning said exception to said provider trading system via said provider communications interface.

57. The method of claim 55, further comprising:
determining a customer current requested trading level, a global current requested trading level,
decrementing said customer current requested trading level and said global current requested trading level by said OTD value; and
incrementing said customer current actual trading level and said global current actual trading level by said OTD value.

58. The method of claim 55, further comprising:
providing a liquidity status database; and
retrieving said customer current actual trading level and said global current actual trading level from said liquidity status database.

59. The method of claim 55, further comprising:
establishing an OTD duration; and
while said offer to deal database contains a stored offer to deal, iteratively performing the following steps (a)-(c);
(a) retrieving said stored offer to deal from said offer to deal database, said stored offer to deal having a stored OTD value;
(b) determining an age for said stored offer to deal; and
(c) if said age does not exceed an established OTD duration, then
(i) retrieving from a liquidity status database a stored customer trading limit, a stored customer current actual trading level, a stored global trading limit and a stored global current actual trading level, and
(ii) if the sum of said stored customer current actual trading level and said stored OTD value does not exceed said stored customer trading limit and the sum of said stored global current actual trading level and said stored OTD value does not exceed said global trading limit, then sending said stored offer to deal to said related provider trading system,
else, deleting said stored offer to deal from said offer to deal database.

60. The method of claim 59, further comprising receiving said OTD duration from said provider trading system via said provider communications interface.

61. The method of claim 59, further comprising:
receiving from said provider trading system, via said provider communications interface, a response to said stored offer to deal;
deleting said stored offer to deal from said offer to deal database; and
decrementing said stored customer current actual trading level and said stored global current actual trading level by said stored OTD value.

62. The method of claim 59, further comprising:
providing a liquidity status database; and
storing in said liquidity status database one or more of said customer current requested trading level,
said global current requested trading level,
said customer trading limit,
said global trading limit,
said OTD duration, and
said exception.

63. The method of claim 62, further comprising providing said provider trading system with access to data stored in said liquidity status database via said provider communications interface.

64. A computer system for processing offers to deal in an online asset trading system, comprising:
means for receiving from a provider trading system a customer trading limit for a customer trading system;
means for determining a customer current trading level for said customer trading system;
means for receiving an offer to deal from said customer trading system, said offer to deal comprising an OTD value; and
means for rejecting said offer to deal if the sum of said customer current trading level and said OTD value exceeds said customer trading limit.

65. The computer system of claim 64, further comprising means for sending said customer trading system a rejection notice.

66. The computer system of claim 64, further comprising means for sending an exception notice to said provider trading system.

67. The computer system of claim 64, further comprising means for storing said offer to deal.

68. The computer system of claim 64, further comprising means for sending said offer to deal to said provider trading system if the sum of said customer current trading level and said OTD value does not exceed said customer trading limit.

69. The computer system of claim 68, further comprising means for incrementing said customer current trading level by said OTD value.

70. The computer system of claim 69, further comprising:
means for receiving from said provider trading system a response to said offer to deal; and
means for decrementing said customer current trading level by said OTD value.

71. The computer system of claim 64, further comprising:
means for establishing an OTD duration;
means for receiving from said customer trading system interface a second offer to deal;
means for calculating an age for said offer to deal; and
means for rejecting said second offer to deal if said age is less than or equal to said OTD duration.

72. The computer system of claim 71, further comprising means for receiving said OTD duration from said provider trading system.

73. The computer system of claim 64, further comprising:
means for receiving from said provider trading system a global trading limit;
means for determining a global current trading level; and
means for rejecting said offer to deal if the sum of said global current trading level and said OTD value exceeds said global trading limit.
